(19) United States
(12) Patent Application Publication
(10) Pub. No.: US 2013/0339489 A1
(43) Pub. Date: Dec. 19, 2013

(54) MOBILE COMPUTING APPLICATION FOR ROADWAY PAVEMENT DATA

(71) Applicants: Sailesh Katara, Bellevue, WA (US); George White, Seattle, WA (US); Joe Mahoney, Seattle, WA (US)

(72) Inventors: Sailesh Katara, Bellevue, WA (US); George White, Seattle, WA (US); Joe Mahoney, Seattle, WA (US)

(21) Appl. No.: 13/689,297

(22) Filed: Nov. 29, 2012

Related U.S. Application Data
(60) Provisional application No. 61/565,070, filed on Nov. 30, 2011.

(51) Int. Cl. H04W 4/04

(52) U.S. Cl. CPC H04W 4/046
USPC 709/219

(57) ABSTRACT

A system configured to collect and disseminate measurements regarding a roadway condition. The numerical measurements may include pavement construction material temperature, material density, photographs, videos, location information (GPS, GIS, station and offset, etc.), timestamp, text, audio, calculated values, detected values (for example roadway ride quality based on calibrated mobile device internal accelerometer). The system may also disseminate information to the mobile devices with construction project/asset specific information. For example, information can include training or educational content on how to perform a specific measurement or procedure to properly acquire a data sample in the field. For example, the information sent to the mobile device can use real-time information such as device location to determine if the system user is near a point of interest where a particular data sample should be measured and recorded. Data uploaded to the cloud-based storage environment may be made immediately available to one or more other credentialed users for real-time project tracking

### PRIORITY CLAIM

This application claims priority from U.S. Provisional Patent Application No. 61/099,384 filed on Nov. 30, 2011, and the subject matter of which is incorporated herein by reference in its entirety.

### FIELD OF THE INVENTION

This invention relates generally to measuring and testing of roadways and, more specifically, to determining the relative location of measurements and observations, and to storage and processing of information in a computer program.

### BACKGROUND OF THE INVENTION

Agencies that own and operate roads typically keep extensive records about their construction, maintenance, and condition. Pavement construction may involve inspection and testing to verify contractor compliance with specifications and ensure that the pavement has the desired characteristics. For proper upkeep, roadway pavements require periodic inspection so the agency can plan, schedule, and prioritize repairs. Throughout the life cycle of the roadway, pavement condition and characteristics can be tracked using this information. For ease of review, the data collected from these inspections is commonly stored in computerized databases, and specialized software programs are used to review and analyze the data. Ongoing data collection is performed in the field, often recorded on paper forms. The data must then be separately entered into computerized databases at a later point. This manual process can be error-prone and lead to incorrect information in the computerized databases.

In order to manage a large road network, agencies typically break the network up into segments for management and inspection purposes. Pavement and inspection data is collected using various measuring instruments supplemented by visual observation. Conventional measuring instruments are self-contained and do not communicate measurement results directly to the computerized databases. The diversity of systems involved in data collection may also lead to inconsistencies in how data is processed, formatted, and archived.

Currently, data is stored in both paper format and in computerized systems, but there are no means for quick retrieval of the information that is stored. Moreover, this information is not easily accessible when in a location out in the field.

### SUMMARY OF THE INVENTION

The present invention generally relates to a system and method for collecting and disseminating data to and from the field for a roadway condition while leveraging capabilities of a portable computer processing system such as, but not limited to a handheld mobile device. The system takes into account both wirelessly connected and disconnected environments integrating connection detection for intelligent synchronization to a cloud-based software service. For example, data collected on the mobile devices can include numerical measurements such as pavement construction material temperature, material density, photographs, videos, location information (GPS, GIS, station and offset, etc.). timestamp, text, audio, calculated values, detected values (for example roadway ride quality based on calibrated mobile device internal accelerometer). The system will leverage widely available inexpensive mobile device capabilities including smartphone/tablet cameras, GPS chipsets, accelerometers, audio microphones, LED lights, etc. to collect and correlate data for specific construction and asset tracking projects. In addition to data collected and intelligently synchronized from mobile devices in the field, the system will disseminate information to the mobile devices with construction project/asset specific information. For example, information can include training or educational content on how to perform a specific measurement or procedure to properly acquire a data sample in the field. For example, the information sent to the mobile device can use real-time information such as device location to determine if the system user is near a point of interest where a particular data sample should be measured and recorded. As data is uploaded to the cloud-based storage environment, it is made immediately available to one or more other credentialed users for real-time project tracking The invention can also allow for formal data integration with other, separate data management systems by providing a data sharing system interface with the data stored within the invention's cloud-based data system. The data can be protected by using security protocols (for example 128-bit SSL encryption) for data exchanged from the mobile device to the cloud-based system backend to the web or client-side application based tracking component.

In accordance with an aspect of the invention, a system for processing roadway pavement data includes a mobile device having a processor and a memory in communication with an application for managing roadway pavement data; a cloud-based server for receiving and storing the roadway pavement data from the mobile device; and a sensor within the mobile device, the sensor configured to determine a characteristic of a section of pavement.

In accordance with another aspect of the invention, a method for communicating roadway pavement data includes the steps of: (1) entering roadway pavement data into an application on a mobile device; (2) determining a location of the mobile device; notifying a user of the mobile device that the device is near a point of interest for taking a data sample; (3) transferring the data from the application to a cloud-based storage environment; and (4) accessing the data in real time from the cloud-based storage environment to monitor a pavement construction project.

### BRIEF DESCRIPTION OF THE DRAWINGS

Preferred and alternative embodiments of the present invention are described in detail below with reference to the following drawings:

FIG. 1 schematically shows a system for processing roadway pavement data according to an embodiment of the present invention;

FIG. 2 shows a graphical user interface for a mobile application configured to receive, transmit and process roadway pavement data according to an embodiment of the present invention; and

FIG. 3 is a flow diagram for receiving, transmitting and processing roadway pavement data according to an embodiment of the present invention.

### DETAILED DESCRIPTION

An application that runs on a portable device with a computer operating system, which allows the user to retrieve data from a computerized database of pavement information, collect new information and update the data in the system. The application allows a person in the field to accurately locate and map large network segments and organize the data in a coordinated and less error prone manner.

The present invention comprises a system for an application for a device such as a mobile phone or portable computer, comprising a computer software program to retrieve data relating to roadway pavements from a remote server, an input interface for the device user, and the ability to collect data from the site where the device is located, which is used to update and change the data located on the remote server.

In accordance with some examples of the invention, the application uses a Global Positioning System (GPS) to identify the location of the device when data is collected.

In accordance with other examples of the invention, the application records the location indicated by the GPS in association with the updates to the pavement data.

In accordance with still further examples of the invention, the application can accept input of pavement density data collected by the device or supplied via the user interface.

In accordance with yet other examples of the invention, the application can accept input of pavement temperature data collected by the device or supplied via the user interface.

In accordance with still another example of the invention, the application can accept input of pavement depth information collected by the device or supplied via the user interface.

In accordance with still further examples of the invention, the application can import photographic images of the roadway pavement captured by the device and associate these with the pavement data.

In accordance with still another example of the invention, the application can accept the location of pavement cores and material samples for subsequent testing using information collected by the device or supplied via the user interface.

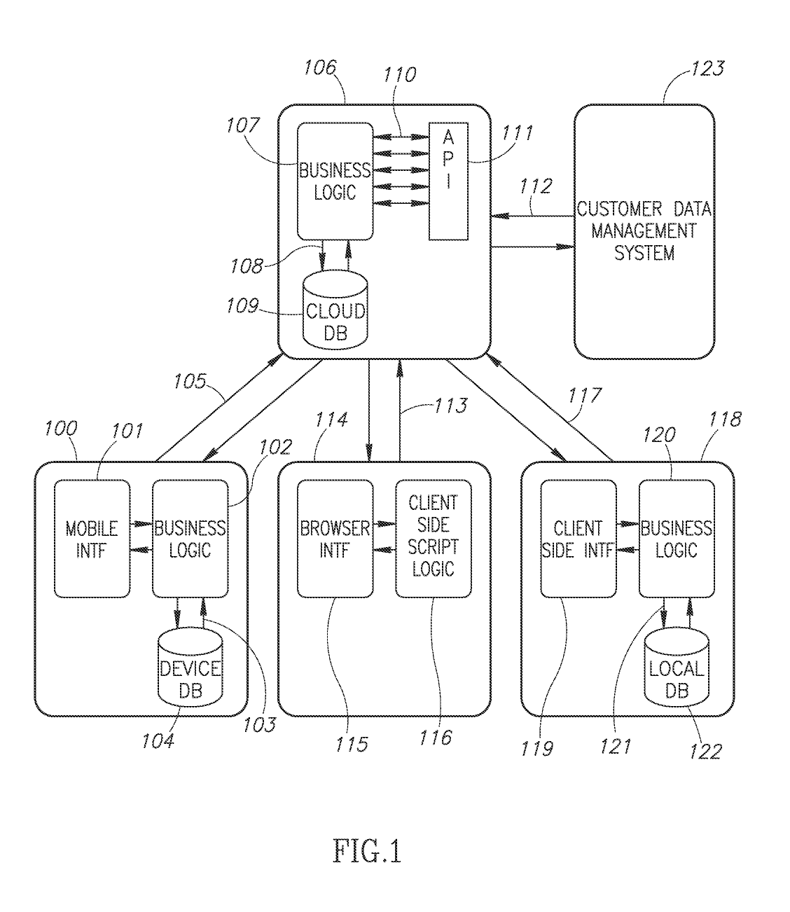

FIG. 1 is a schematic diagram of a software system for collecting and disseminating data to and from the field using commodity/inexpensive/readily available handheld mobile devices. The mobile application 100, web application 114, and client-side application 118 are all possible embodiments of the software system components that allow users to collect and retrieve data. These software components can run on portable or mobile computing devices such as mobile phones or tablets, traditional desktop computers, consoles that are equipped with web browsers, or other general computing devices. These software components can be connected to the internet via wireless or wired connections allowing communication with a cloud-based software service referred to as a cloud application 106 via secured internet connections (105, 113, 118) where data can be stored and accessed. For example, data can include numerical measurements such as pavement construction material temperature, material density, photographs, videos, location information (GPS, GIS, station and offset, etc.), timestamp, text, audio, calculated values, detected values (for example roadway ride quality based on calibrated mobile device internal accelerometer).

The mobile application 100 component of the software system can have a mobile interface 101 where users view and input data collected in the field. For example, a user can enter a pavement construction characteristic observed in the field for pavement density, associate it to a specific construction project, and connect that piece of data entered by the user with a timestamp and location (GPS or GIS) information. This information once entered by the user into the mobile interface gets passed to the business logic component 102 where the information can be processed and organized. The data can be saved 103 to a local device database 104 as a source record. The business logic can also detect internet connectivity 105 where, if connected, the data saved in the local device database can be sent to the cloud application 106 for data synchronization and other processing and an acknowledgement sent back to confirm the transaction with the cloud application. This allows the mobile application component 100 to operate in conditions where internet connectivity is available (“online mode”) or where internet connectivity is not available (“offline mode”).

The business logic 102 component can process data by providing automatic calculations ranging but not limited to simple arithmetic calculations to formulaic or functional calculations allowing the user in the field to use the mobile application 100 to automate previously hand calculated data values in the field. In addition, the business logic 102 can use the hardware sensors (camera, microphone, accelerometer, etc.) available on the mobile device to collect data directly as well as process that data into a value or values that are pertinent to the domain of the invention. For example, many mobile devices contain accelerometers. The business logic 102 can use the accelerometer to detect and output values for pavement smoothness and correlate them, for example, to the International Roughness Index (IRI). Many devices also now provide touchscreen displays allowing users to draw and interact visually. The mobile application 100, for example, can display visual representations such as pavement distress and condition grids for field inspectors to diagram and record condition observations while visiting a project.

The business logic 102 component can also improve the accuracy of the location (GPS or GIS) information obtained from the mobile device by allowing the system user to calibrate the location reading to a known location by selecting a prominent location visible on a map view available from the mobile interface 101 and matching the user's actual physical location with that location and synchronize the GPS or GIS location reading from the mobile device.

In addition to collecting and sending data to the cloud application 106, the mobile application 100 can receive 105 real-time information from the cloud application 106. For example, based on the location (GPS or GIS) of the mobile device, points of interest specific to the item being tracked can be sent from the cloud application 106, received and processed by the business logic 102 to trigger a notification to the user via the mobile interface 101 visually, audibly, or vibrating the mobile device, for example prompting the user to collect a specific data sample at a particular location. Another example of information that may be transmitted from the cloud application 106 to the mobile application 100 can be instructional or training information including but not limited to instructive photographs, images, animations videos, audio files how a particular data sample procedure can be performed properly. This training or instruction can be embedded directly into the mobile interface 101 and provides relevant information to the system user in a timely way directly related to the data collection activity being performed at that time. It should be noted that this instructional information can be dynamic as policies and procedures may vary not only based on project type, but on policies and procedures provided by project decision makers.

Information that is available outside of the system via access to the internet can also be accessed and used. For example, weather information (i.e., ambient temperature) can be pulled from existing internet data sources based on the location information provided from an instance of the mobile application component 100. This data request, for example, will flow from the mobile application component 100 through the communication link 105 to the cloud application component 106 through the business logic 107 out to the internet based data service. The retrieved data will flow back to the mobile application component 100 in the opposite sequence.

Data and information transmitted between the cloud application 106 and the mobile application component 100, web application component 114, and client-side application component 118 can be encrypted to protect the data using security protocols (for example 128-bit SSL encryption).

The cloud application component 106 can handle multiple simultaneous connections. It provides a true multi-user environment. Additionally, this component is a program that is multi-tenancy, allowing it to serve multiple customer organizations from a singular running instance of the system.

The system includes role-based security, which allows users with proper credentials to access system functionality and information based on their role and/or permission level. For example, a field inspector can be allowed access to data related to a particular paving project, while a department executive can be allowed access to information for multiple projects within the system.

As data is uploaded and synchronized with the cloud database 109, the data will be searchable and accessible by users with proper access credentials in real-time. This allows for live updates and tracking, for example, by supervisors to examine project progress as it occurs in real-time.

Data and information stored within the cloud database 109 can be accessed by third party systems, such as a customer data management system 123, via the cloud application component's 106 application programming interface (API) 111. The API provides a series of computer program routines, data structures, object classes, and variables allowing third party software systems to directly communicate with the cloud application component 109 to securely receive and send data. This will allow data available within the current invention to be directly integrated within customer organizations' existing systems, allowing for further analysis and use.

The client-side application component 118 may run on a more traditional desktop or laptop computing environment rather than on a mobile device such as a smartphone or tablet. The capabilities of the client-side application are similar to that of the mobile application component 100, but depend on the hardware capabilities available. The hardware functionality can be automatically detected by both the mobile application component 100 and the client-side application component 118. For example, a desktop computing device may not contain a camera for collecting and tagging photographs for a project. The client-side application can more commonly be used for data retrieval and review, for example, by supervisors to examine the data collected in the field by their inspectors. The client-side application component 118, as it also contains a local database 122 can operate in either a connected 117 or a disconnected environment as described for the mobile application component 100.

The web application component 114 allows users access to the data stored within the cloud application component 106 using a standard web browser with a connection to the internet. This component can operate only while connected to the internet 113 as it contains no mechanism for local data storage for synchronization with the cloud application component 106 at a time when connectivity is available.

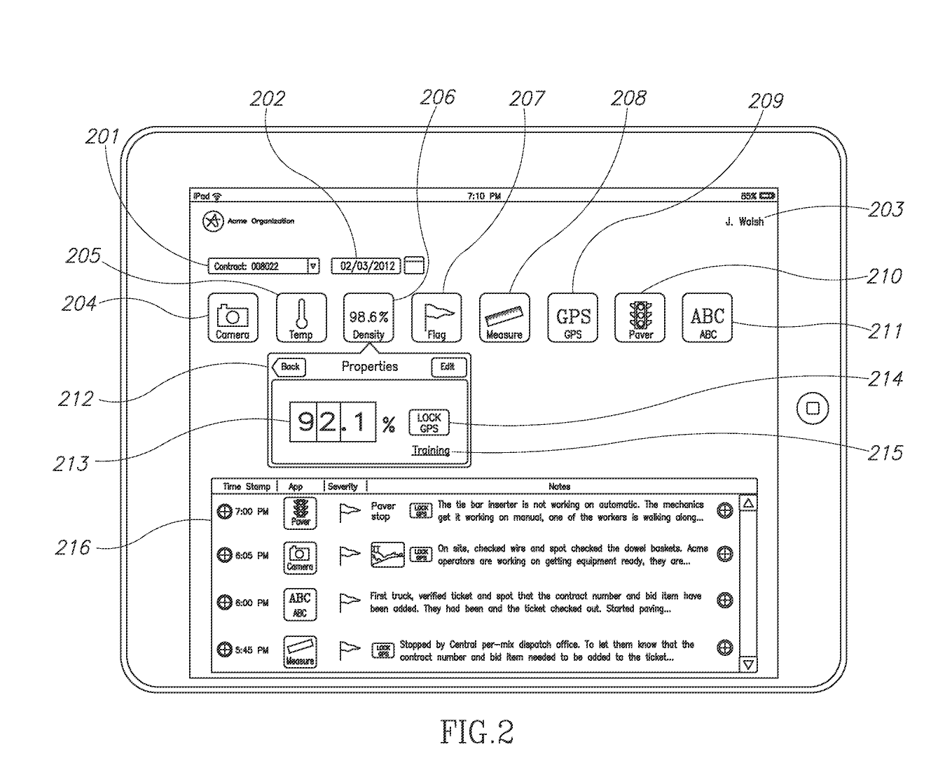

FIG. 2 shows a graphical user interface for a mobile application configured to receive, transmit and process roadway pavement data according to an embodiment of the present invention. The graphical user interface allows particular users 203 to login and gather data from in the field and correlate that data directly with specific projects 201 to which they are allowed access. For example, a Department of Transportation may have a roadway about which an inspector must collect data to document pavement condition or construction practices periodically. One example of data that can be collected includes pavement density measurements 213. From the graphical user interface, a user can open a data entry box 212 to collect these measurements by selecting the density interface button 206. Within the data entry box 212, the pavement density value can be entered 213 and correlated with the location information 214 (for example GPS). Once entered, the user can save the values in the system which will automatically correlate the value to that specific project or road segment 201 including corresponding time/date stamp 202. In addition, the user can access training 215 to illustrate how to properly gather the value being collected. The training may, for example, contain a short video to illustrate the proper procedure to collect a pavement density value. This training can be presented using a combination of text, images, graphics, video, and animation that pops up and displays directly within the graphical user interface of the mobile application. Once the data is entered, it can be saved in real-time to the device database 104 and uploaded the cloud application component 106. This data can also appear in the data feed 216 for the project which is accessible within the mobile application graphical user interface 101, the web application interface 115, and the client-side application interface 119.

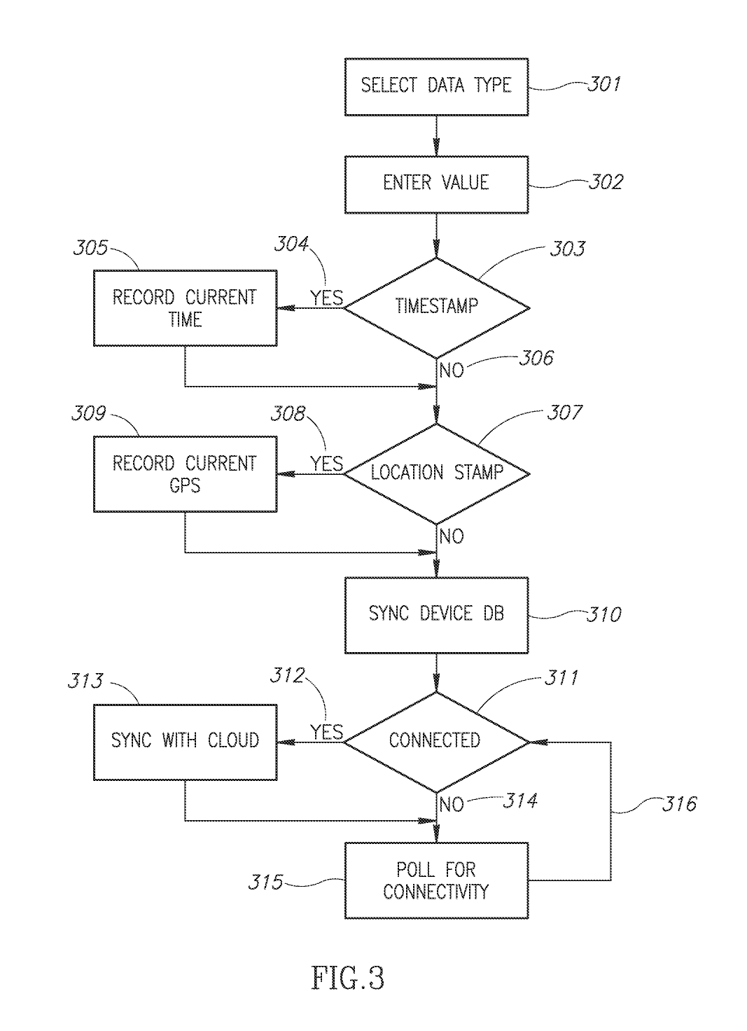

FIG. 3 shows a flow diagram for the mobile application 100 to select and enter data, tie it to temporal and location information, and record and upload that data based on connectivity detection. The first step for a user within the graphical user interface 101 of the mobile application component 100 is to select the data type 301 of the data to enter. For example, in the pavement field, the temperature of the placed material is critical for proper construction. Once the data type is selected, the user can enter the value 302 to record. That data is then error checked dynamically based on data type to ensure values entered fall within valid ranges. This can eliminate the majority of data entry errors that occur in the field. Once the data is entered, if timestamp recording is enabled 303, the time and date is captured and correlated 305 with the data value. Next, if the user decides to capture the location information (for example GPS or GIS) 307, the current GPS location is captured and correlated with the data value as well 309. Once these data components are captured, the user can direct the mobile application 100 to record these values 310 in the local instance of the device database 104. Once the data is properly stored in the local database the business logic component 102 from the mobile application 100 can check for connectivity to the cloud application 106 by sending a request/response message 311. If the mobile application detects connectivity 312 to the cloud application, the mobile application can synchronize the data recorded by uploading it to the the cloud application and awaiting a transaction successful confirmation from the cloud at which point it can set a status indicator flag in the local device database 104 indicating the data recorded is synchronized with the cloud application. If connectivity is not detected 314, the mobile application can periodically (for example once every 1 second) poll for connectivity 315 to the cloud application by sending the request/response message to the cloud application 106. When connectivity is detected 312, the data can be synchronized with the cloud application 313.

Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for communicating roadway pavement data, the method comprising:
entering roadway pavement data into an application on a mobile device;
determining a location of the mobile device;
notifying a user of the mobile device that the device is near a point of interest for taking a data sample;
transferring the data from the application to a cloud-based storage environment; and
accessing the data in real time from the cloud-based storage environment to monitor a pavement condition.

2. The method of claim 1 wherein the roadway pavement data includes data electronically received by the mobile device.

3. The method of claim 1 wherein the roadway pavement data includes data manually input into the mobile device.

4. The method of claim 1 wherein the roadway pavement data includes data detected by the mobile device.

5. The method of claim 4 wherein detecting the data includes recording a ride quality of a paved road segment using an accelerometer within the mobile device.

6. The method of claim 1 wherein determining a location includes determining a geographic position of the mobile device using a global positioning system.

7. The method of claim 1 wherein accessing the data in real time includes using the data to track a progress of the pavement condition.

8. The method of claim 1, further comprising receiving an instructional message on how to properly take the data sample.

9. The method of claim 1, further comprising displaying a visual representation of a characteristic of a paved road segment.

10. A system for processing roadway pavement data, the system comprising:
a mobile device having a processor and a memory in communication with an application for managing roadway pavement data;
a cloud-based server for receiving and storing the roadway pavement data from the mobile device; and
a sensor within the mobile device, the sensor configured to determine a characteristic of a section of pavement.

11. The system of claim 11 wherein the sensor includes a global positioning system.

12. The system of claim 11 wherein the sensor includes an accelerometer.

13. The system of claim 11 wherein the sensor includes a temperature sensor.

14. The system of claim 11 wherein the application includes a graphical user interface.
